(19) United States
(12) Patent Application Publication
(10) Pub. No.: US 2005/0000311 A1
(43) Pub. Date: Jan. 6, 2005

(54) Actuator system

(76) Inventor: Stefan Storm, Unterschleissheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/484,074

(22) PCT Filed: Jul. 10, 2002
(86) PCT No.: PCT/DE02/02517

(30) Foreign Application Priority Data
Jul. 17, 2001 (DE) 101 34 737.5

(51) Int. Cl. G05G 11/00

(52) U.S. Cl. 74/490.07

(57) ABSTRACT

The aim of the invention is to produce an actuator system which also carries out combined adjusting movements, comprising linear and rotating displacement components. As a result, the actuators are connected together at the end points thereof by means of corner connections in such a manner that they form a closed, polygonal arrangement; the opposite corner connections of the actuator system are held together at a constant distance therebetween by means of rigid connections; the rigid connections can move freely with respect to each other and are connected in a flexible manner to the respective corner connections; the actuator system forms two outputs with the opposite corner connections.

The invention concerns an actuator system consisting of several interacting actuators, in accordance with the preamble of patent claim 1.

Known actuator systems with several interacting actuators execute either linear adjusting motions (DE-C2-196 44 161) or rotating adjusting motions (EP-A1-648976).

The invention is based upon the objective of creating an actuator system that also performs combined adjusting motions comprised of linear and rotating motion components.

This objective is accomplished in accordance with the invention through the characterizing features of patent claim 1. Further developments of the invention are indicated in the dependent claims.

The actuator system of the invention possesses three degrees of freedom; two for linear adjusting motions—one in the x axis and one in the y axis of an x-y plane—and one for a rotating adjusting motion around the z axis, which stands as a normal vector in the origin of the x-y system.

All motion components of the actuator system of the invention can be combined and spectrally superimposed in any desired manner. In this way, rotary motions around any desired axes of rotation can also be advantageously performed parallel to the z axis.

In addition to the function of an adjuster, the actuator system can also be used in conjunction with an interfaced inertial mass as an adaptive vibration eliminator (even for rotary systems), as an inertial vibrator or as a sensor.

The actuator system of the invention has the advantage that the idling extension and the blocking force can be individually adapted to the respective application.

The actuator system of the invention further has a compact construction and possesses the advantages of a counter-player system due to the arrangement and type of the electrical activation, such as, for example, a temperature-compensated and linearized actuator stroke. Further advantages are a randomly adjustable, mechanical prestressing of the actuators and the avoidance of force-path losses that occur in known systems with mechanical prestress springs.

In choosing a suitable angular geometry for the actuator system, geometry-conditioned reinforcements or weakenings can be attained, with high dynamics and a very high effectiveness level, with the initiated linear and/or rotary adjusting motions. For this, it is necessary to deviate from a 90° angle arrangement for the actuators.

The force distribution and consequently the prestressing level of the individual actuators changes during the operation of the actuator system of the invention. This effect advantageously enlarges the geometric translation of the actuator system of the invention. The mechanical prestressing of the positively activated actuators is reduced, and the actuators can be additionally stretched in this way. The actuators activated in a negative direction experience an increase in mechanical prestressing, and consequently an additional shortening. This behavior of the actuator system of the invention, which acts like a negative load rigidity, can advantageously equalize the small actuator stroke that is system-conditioned in piezoelectric actuators.

The moved masses of the actuator system of the invention can be kept very small, owing to which high dynamics are possible.

Exemplary embodiments of the invention are explained in greater detail below with reference to the drawing, wherein:

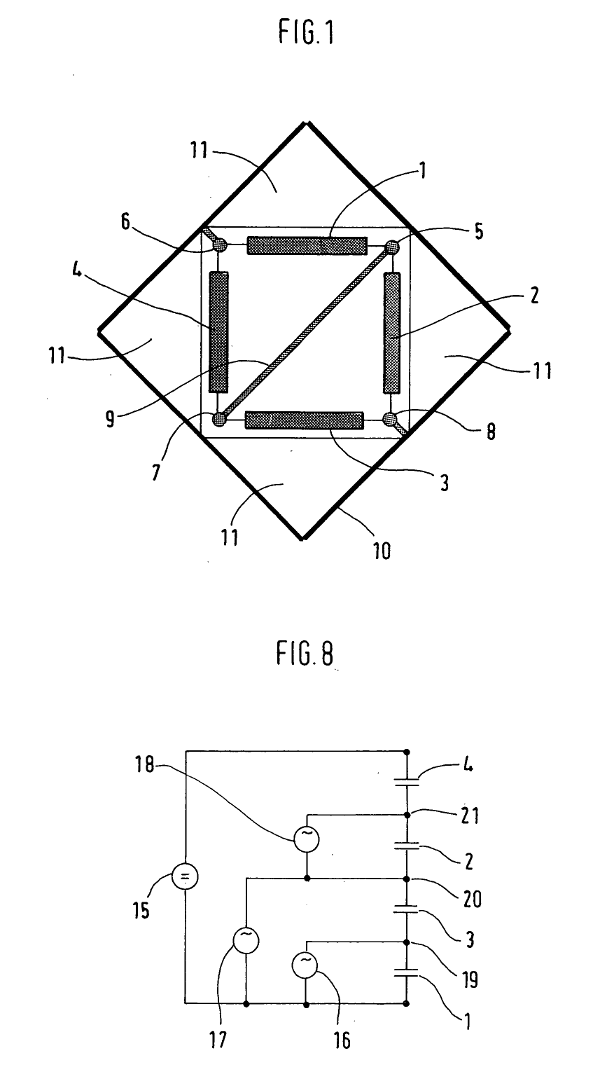

FIG. 1 Illustrates an actuator system of the invention, which is optionally constructed as a vibration eliminator,

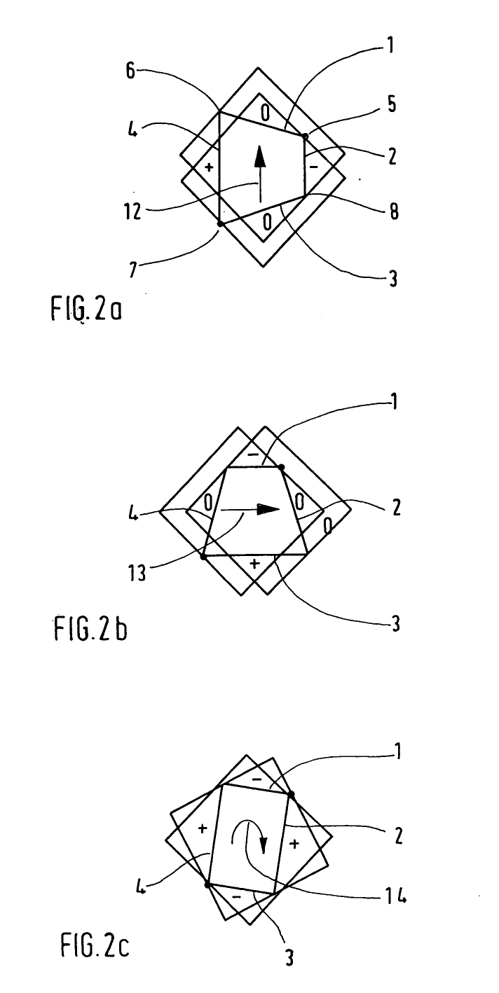

FIG. 2 Illustrates the possible motion components of the actuator system of the invention,

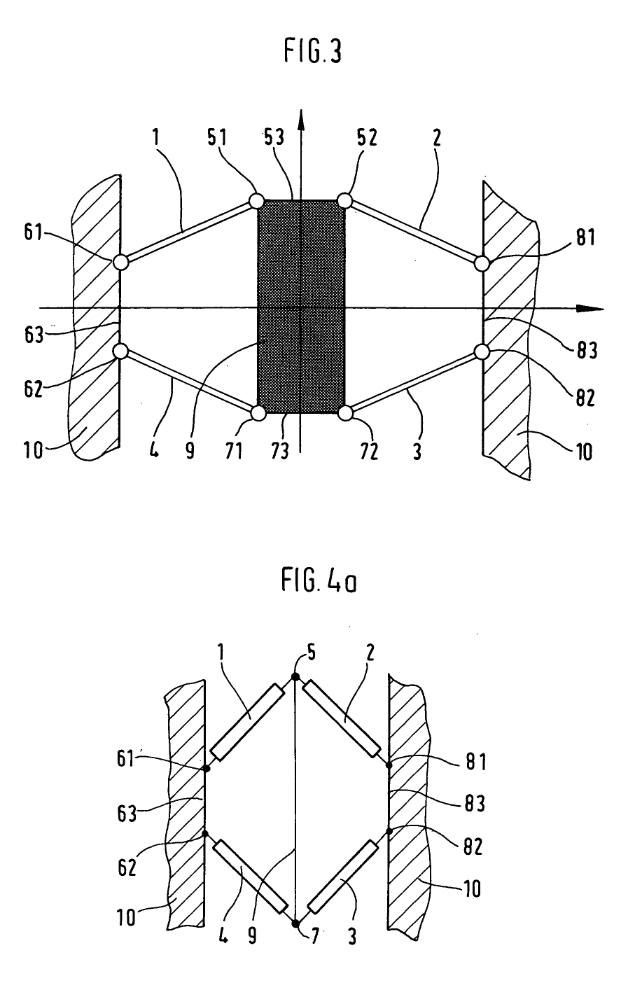

FIG. 3 Illustrates the actuator system of the invention in a general embodiment,

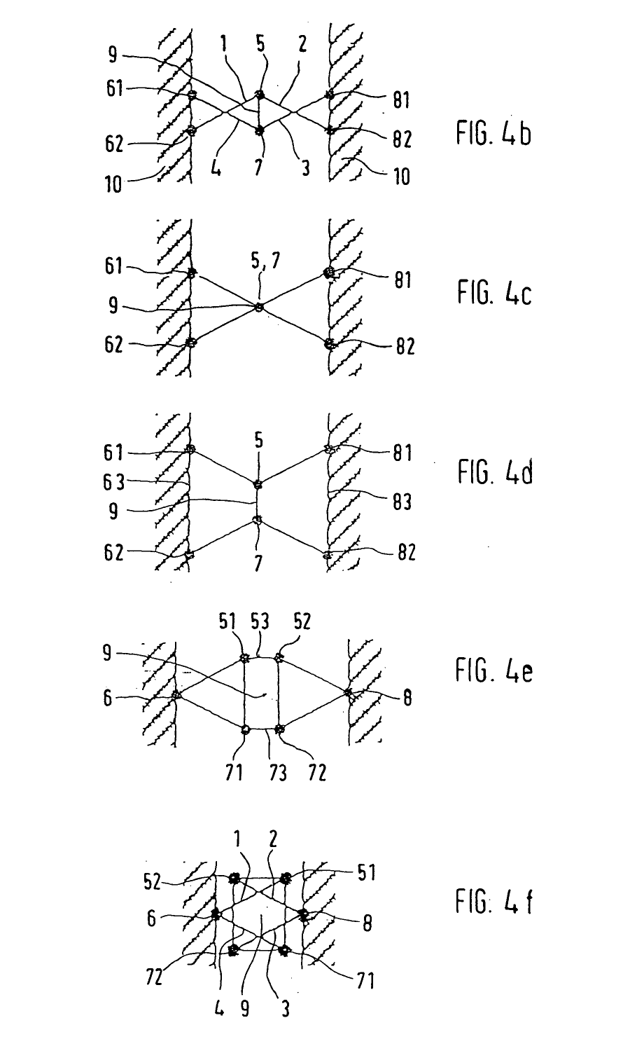

FIG. 4a to FIG. 4f Illustrate further construction variants of the actuator system,

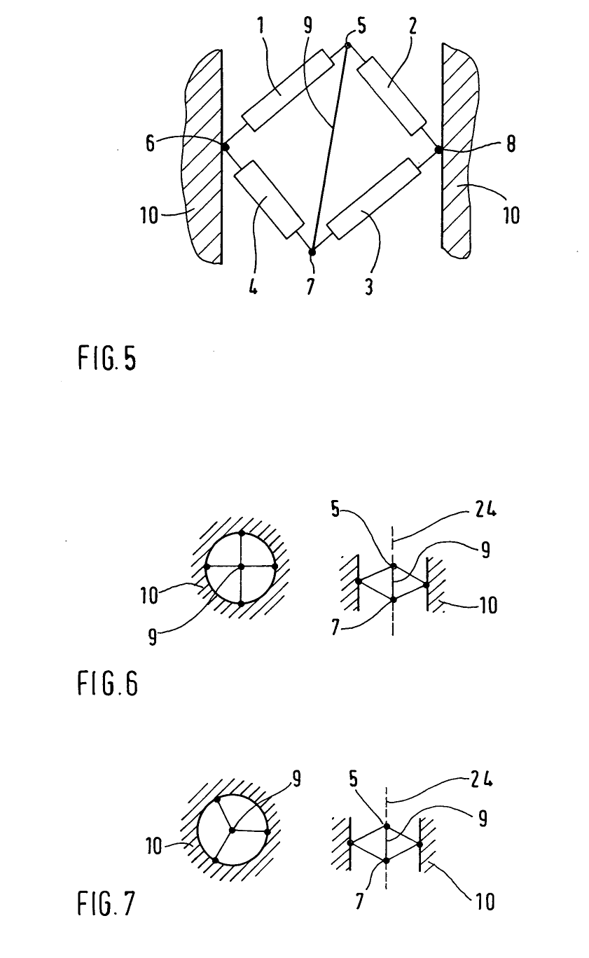

FIG. 5 Illustrates an actuator system with variously constructed actuator pairs,

FIG. 6 and FIG. 7 Respectively illustrate an actuator system in which the actuators are arranged rotation-symmetrically around an output axis,

FIG. 8 Illustrates an electric control circuit for an actuator system that is used as a counter-player and

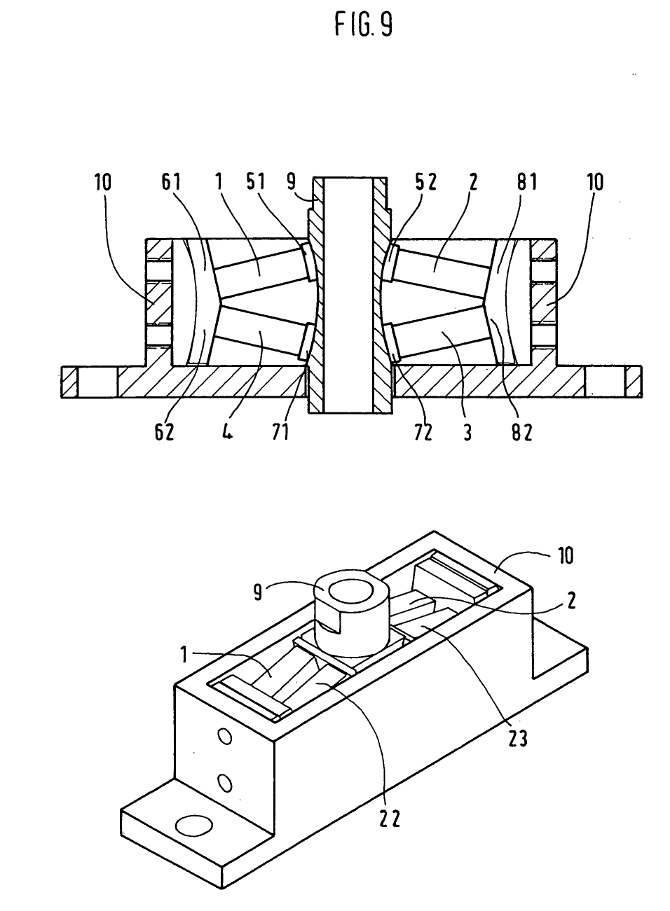

FIG. 9 Illustrates a constructional execution of the actuator system, which acts as an adjuster with geometry-amplified adjusting motion.

The actuator system illustrated in FIG. 1 consists of four actuators 1 to 4, four corner connections 5 to 8, two rigid connections 9, 10 and inertial masses 11 mechanically coupled to the actuator system.

The four actuators 1 to 4 are identically designed in their dimensions and rigidity characteristics. They are connected at an angle to one another with their end points through corner connections 5 to 8 such that they form a closed rectangular arrangement. The opposed corner connections 5 and 7 as well as 6 and 8 of the actuator system are respectively held at a constant distance from one another by means of rigid connections 9, 10; for example by means of a rod between the corner connections 5 and 7, or by means of an external frame that encloses the actuator arrangement and is connected to the corner connections 6 and 8.

Alternatively, only rods or only external frames could be used between the two opposite corner connections. It is crucial that the opposite corner connections are always kept at a constant distance from one another, and that the apparatuses used for this are freely movable relative to one another. Instead of the external frame, which in FIG. 1 is illustrated as a closed rectangular configuration, for example, any random frame-like configuration could also be used which can keep the two corner connections at a constant distance; for example a half frame or any other external bracing points with which the corresponding corner connections are joined.

The corner connections 5 to 8 can be designed as flexible connections in reference to which the angles between the actuators can be varied during the operation of the actuator. Flexible corner connections are, however, no precondition for the solution of the invention; it can also be implemented with rigidly bent corner connections. The apparatus for maintaining constant distances (rods or frames) are flexibly connected with the respective end connections.

The actuator system possesses two outputs, wherein the two respectively form the output points for an output on corner connections that are maintained at constant distance.

Optionally, a mechanical prestressing can be exerted upon the actuators 1 to 4 by means of a corresponding dimensioning of the constantly maintained distances between the corner connections, which prestressing is necessary for certain actuators that may not be stressed under tension, for example when using piezoelectric stack actuators.

Any desired electrically controllable actuators with mechanical adjusting motions can be used as actuators 1 to 4 in addition to the previously mentioned piezoelectric stack actuators; for example, piezoelectric fiber actuators or pneumatically operating actuators.

Since the actuator system illustrated in FIG. 1 is optionally constructed as a vibration eliminator, inertial masses 11 are additionally mechanically coupled to the frames, respectively in the corners of the frames. Without this coupling of the inertial masses, a normal actuator system with outputs for adjusting motions would exist with the previously described system.

The form and binding of the inertial masses 11, as distinct from the type of construction illustrated here, is alternatively configurable, and can in this way be adapted to the constructional features of the vibration eliminator. The inertial masses 11 could, for example, also be additionally coupled to the rod or to both outputs (to the rod and to the frames).

FIG. 2a illustrates the actuator system during execution of a linear motion component in the x-y plane of the actuator system. That is the plane in which the actuators 1-4 are arranged. The actuators 1 to 4 are electrically activated such that one actuator 2 has a compression in relation to a mechanical offset value that corresponds to its mechanical prestressing, and the opposite actuator 4 has an extension. The opposed actuators 1 and 3 are electrically activated such that neither a compression nor an extension occurs in relation to their mechanical offset value. In FIG. 2a and the subsequent FIGS. 2b and 2c, an extension is designated with a +, a compression with a −, and a neutral activation of the actuators with 0.

With the previously described activation of the actuators, the distances between the corner points 5 and 7 and between the corner points 6 and 8 necessarily remain constant, owing to the action of the rigid connections 9 and 10.

The activated actuator system (as previously described) executes with its two outputs a self-overlaying adjusting motion in the direction of the motion arrow 12.

In FIG. 2b, the actuators 1 to 4 are activated such that a linear adjusting motion in the direction of the motion arrow 13 results for the actuator system. For this, actuator 1 is compressed, actuator 2 is neutral, actuator 3 is extended, and actuator 4 is neutral. The motion component that is generated is likewise situated in the x-y plane and stands perpendicular on the motion components illustrated in FIG. 2a.

In FIG. 2c, the actuators 1 to 4 are activated such that the actuator system executes a pure rotational motion in the direction of the motion arrow 14. For this, actuator 1 is compressed, actuator 2 is extended, actuator 3 is compressed, and actuator 4 is extended. The axis of rotation of these motion components that are generated stands perpendicular in the x-y plane of the actuator system.

The three motion components described above in reference to FIGS. 2a to 2c can be combined in any desired manner and spectrally superimposed by a corresponding activation. To maintain a constant mechanical prestressing in the actuators, a constant electrical summation voltage must be maintained in connection with the activation.

Deviating from the above-described exemplary embodiments, the actuators 1 to 4 can also be arranged in other polygons and shapes through suitable configurations and arrangements of the corner connections 5 to 8, wherein the solution of the invention can be adapted to different constructional requirements.

FIG. 3 illustrates the actuator system of the invention in a general embodiment from which numerous variants can be derived.

In this embodiment, all corner connections 5 to 8 are separated by pairs into corner connections 51 and 52, 61 and 62, 71 and 72, and 81 and 82. The rigid connections 9 and 10 known from the previously described embodiment are respectively arranged between two opposed pairs of corner connections, wherein the rigid connection 10, for example, is constructed as an enclosing frame.

The corner connections in each case have a rigid distance 53, 63, 73 and 83 toward one another on the rigid connection 9 and the rigid connection 10. The corner connections themselves can be basically constructed rigidly or flexibly, and both outputs of the actuator system are respectively operative between opposite pairs of corner connections.

Variant constructions that can be derived from the embodiment illustrated in FIG. 3 are described below in an exemplary selection.

FIG. 4a illustrates a hexagonal actuator system. In this actuator system, no rigid distances 53 and 73 are constructed on the rigid connection 9, and the corner connections 51 and 52 as well as 71 and 72 are respectively replaced by a single corner connection 5 or 7, in deviation from the exemplary embodiment illustrated in FIG. 3.

FIG. 4b also illustrates an actuator system that has no rigid distances 53 and 73 on the rigid connection 9. In comparison with the previously described variants, the corner connections are arranged on the rigid connection 10 such that the actuators 1 and 4 as well as 2 and 3 respectively cross over. With an arrangement of this type for the corner connections on the rigid connection 10, the installation height of the actuator system can be advantageously reduced.

FIG. 4c illustrates a pentagonal actuator system. In contrast to the actuator system illustrated in FIG. 4a, the rigid connection 9 is dispensed with here, and the corner connections 5 and 7 are directly connected rigidly or flexibly with one another. Such an arrangement is advantageous when a low torque rigidity is needed for the output on the corner connections 5 and 7.

FIG. 4d illustrates a hexagonal actuator system similar to the actuator system illustrated in FIG. 4a. In deviation from this, the distances 63 and 83 here are greater that the distance specified by the rigid connection 9 between the corner connections 5 and 7.

FIG. 4e illustrates a hexagonal actuator system in which, in deviation from the exemplary embodiment illustrated in FIG. 3, the corner connections installed on the rigid connection 10 are not separated by rigid distances.

FIG. 4f illustrates a hexagonal actuator system based upon the exemplary embodiment in accordance with FIG. 4e. In comparison with the previously described variants, the corner connections are arranged on the rigid connection 9 such that the actuators 1 and 4 as well as 2 and 3 respectively cross over. With such an arrangement of the corner connections on the rigid connection 9, the installation width of the actuator system can be advantageously reduced.

In addition to the selection of construction variants illustrated in FIG. 4a through 4e, still other alternatives for the actuator system of the invention can be derived by a specialist in the field through further variations in the arrangements and designs of the corner connections (not illustrated here). Here it is essential that the opposite corner connections (or corner connection pairs) of the actuators arranged in a closed polygon by rigid connections 9 and 10 be maintained at a constant distance to one another.

A further possibility for alternative embodiments of the actuator system of the invention consists in that the opposed actuators 1 and 3 as well as 2 and 4 are constructed differently in pairs. In the exemplary embodiment illustrated in FIG. 5, for example, the actuators 1 and 3 are constructed longer than the actuators 2 and 4. The different construction of the actuator pairs can, as illustrated in FIG. 5, relate to the dimensioning, but it can also relate to the path and force capacity of the actuators. Basically this principle of the different actuator pairs can be transferred to all the aforementioned embodiments.

Deviating from the previously described embodiments, in which the two outputs of the actuator system operate in the same plane, there also exists the possibility of arranging the actuators rotation-symmetrically around an output axis 24. FIG. 6 and FIG. 7 illustrate embodiments of this type.

The plan view and the elevation in section of such a system are respectively illustrated in the figures. The rigid connection 10, for example, is constructed as a hollow cylinder, and the rigid connection 9 extends in the longitudinal axis of this hollow cylinder. Instead of the cylindrical frame, other constructions of the frame are also conceivable which make possible a rotation-symmetrical arrangement around the output axis 24 for the actuators, for example a square frame. All other previously described embodiments may be transferred to a rotation symmetrical system of this type.

The actuator system of FIG. 6 consists of two actuator arrangements with four actuators each that are incorporated, staggered at 90° in relation to one another in the hollow cylinder. The actuator system of FIG. 7 consists of three half-actuator arrangements of two actuators each, which are incorporated, staggered at 120° in relation to one another in the hollow cylinder.

The actuator arrangements operate on the one hand on the output coupled to the frame and on the other hand together on the second output of the actuator system in the longitudinal axis of the hollow cylinder, which is connected to the corner connections 5 and 7, between which the rigid connection 9 is arranged.

FIG. 8 illustrates an electric control circuit for an actuator system of the invention, which, for example, is used as a counter-player and consists of piezoelectric stack actuators. These possess electric properties like a voltage-controlled condenser, and are represented with the corresponding replacement circuit diagram in FIG. 8.

Th actuators 1 to 4 are arranged electrically in series. Moreover, the sequence is selected such that two opposed actuators are connected directly one after the other, for example in the sequence 4-2-3-1. The actuators connected one after the other is evenly subjected to a direct voltage source 15.

For the individual activation of the actuators, the direct voltage drop is superimposed by an alternating current in the individual actuators, which is fed out of one of three alternating current sources 16, 17 and 18 respectively into one of the connection points 19, 20 and 21 between the actuators of the series connection. The alternating current sources 16 and 18 each lie above the actuator 1 or 2; alternating current source 17 lies above the two actuators 1 and 3.

To generate a vibration of the actuator system in the direction of the motion components in accordance with FIG. 2a, the alternating current source 18 feeds into the connection point 21 when the alternating current source 16 is shut off and the alternating current source 17 is bridged. The actuators 4 and 2 are alternatingly compressed and extended in time with the alternating current. The actuators 1 and 3 are loaded only by the underlying direct current and do not execute any vibration motion. Correspondingly, an additional feed leads to a vibration in the direction of the motion components in accordance with FIG. 2b solely through the alternating current source 16 when the alternating current sources 17 and 18 are shut off.

The infeed of all three alternating current sources leads to a vibrating rotational movement in the direction of the motion components in accordance with FIG. 2c. For this, the alternating currents are fed in such that opposed actuators of the actuator system extend or compress in phase, and a phase opposition exists between the in-phase vibrations of the two actuator pairs.

The previously described control circuit for the actuator system is indicated only by way of example, and for an actuator system that acts as a vibration eliminator. A specialist can modify this control circuit as desired for other uses of the actuator system without having to be inventively active. The possibility of generating the motion components according to FIG. 2a to FIG. 2c in accordance with the invention and the possibility of being able to combine these motion components by means of a corresponding control unit in any desired manner is crucial to the design of alternative control circuits.

A possible refinement of the control circuit consists in the fact that the supply voltage of the alternating voltage sources 16 and 18 is delivered by the primary alternating voltage source 17. In this way, the summation voltage is necessarily always constantly distributed over the four actuators, and no undesired overdriving or undermodulation of the actuators by the subordinate alternating voltage amplifier is possible. A further advantage of this refinement lies in the fact that a rotational movement in accordance with FIG. 2c can be generated by an activation of the alternating voltage source 17 alone. The alternating voltage sources 16 and 18 may only be constructed as proportional amplifiers and not as voltage amplifiers to obtain this advantage.

A further advantageous embodiment of the control circuit relates to the controllability of the offset voltage generated with the direct voltage source 15 as a function of the existing operating conditions. If only few actuator strokes are needed, the offset voltage can be set at a low value. In this way, the lifespan of the actuators can be increased in connection with the use of piezoelectric actuators.

In the constructional application illustrated in FIG. 9, two actuator systems of the invention are used in a parallel acting arrangement. Four actuators 1 to 4 of one of the two actuator systems are recognizable in the section front view. The perspective view shows only the upper actuators 1, 2, 22 and 23 of the two parallel actuator systems. The lower actuators are not recognizable in this view since they are located in a housing, which assumes the function of the rigid connection 10 here.

The housing can optionally be closed with a cover and filled with oil, wherein a good cooling and high electrical strength can advantageously be attained for the actuators. The moved output casing is moreover sealed off with sealing rings toward the housing.

The configuration of the corner connections is characteristic for this constructional execution, in addition to the aforementioned parallel action. The corner connections 61, 62 and 81, 82 have an acute angle between the actuators and an obtuse angle between the corner connections 51, 52 and 71, 72. The angle geometry leads to an amplified motion component in the direction of the longitudinal axis of the rigid connection 9, which is constructed as an output housing. The corner connections of this constructional execution are rigid in relation to the actuators and are not constructed as flexible connections. But they are flexibly connected by means of roller bearing sleeves to the rigid connections 9 and 10.

The motion components in accordance with Figures FIG. 2a to FIG. 2c [sic] and the adjusting motions combined from them can be generated by a corresponding individual electric control of the actuators in the two actuator systems. In any given case, parallel arranged actuators of the two actuator systems must be activated in the same manner. Constructionally conditioned amplifications as a consequence of the angle geometries also act upon the obtainable combined adjusting motions. All motion components act in the x-y plane of the actuators, which extends parallel to the arrangement planes of the actuators.

1-13. (Canceled)

14. An actuator system comprising:
a plurality of interacting actuators; and
a plurality of rigid connections; wherein
said actuators are connected to one another at respective end points via corner connections such that said actuators form a closed polygonal arrangement,
said corner connections opposite from one another are maintained at a constant distance from one another by said rigid connections,
said rigid connections are freely movable relative to one another and are flexibly connected to respective corner connections,
said actuator system forms two outputs with opposite corner connections.

15. The system of claim 14, wherein said actuators are connected electrically in series and are evenly subjected to a direct voltage source.

16. The system of claim 15, wherein, to realize combined adjusting motions, an alternating voltage is imposed upon each of said actuators for its individual control.

17. The system of claim 16, wherein said adjusting motions comprise linear and rotating motion components.

18. The system of claim 17, wherein electrical control of said actuators is designed according to a counter-player system.

19. The system of claim 17, wherein said corner connections are respectively replaced by a pair of corner connections, each of said pair of corner connections being at a rigid distance from the other.

20. The system of claim 17, wherein said corner connections are constructed as rigid or flexible angle arrangements.

21. The system of claim 19, wherein said corner connections are constructed as rigid or flexible angle arrangements.

22. The system of claim 17, wherein said rigid connections are constructed as rods and/or as frames.

23. The system of claim 17, wherein said actuators are constructed as piezoelectric stacks, as piezoelectric fiber actuators, and/or as pneumatic actuators.

24. The system of claim 17, wherein segments of said corner connections are respectively arranged at a same angle toward one another.

25. The system of claim 17, wherein opposite corner connections are executed as acute and obtuse angled angle arrangements.

26. The system of claim 17, wherein, in each case, two opposite actuators are constructed identically.

27. The system of claim 26, wherein each pair of actuators is constructed differently from another pair.

28. The system of claim 17, wherein said actuators are arranged rotation-symmetrically around an output axis.

29. The system of claim 28, wherein said direct voltage source is controllable.

30. The system of claim 29, wherein said system can be subjected to low offset voltage from time to time.

31. The system of claim 28, wherein electrical control of said actuators takes place with a primary alternating voltage source and two subordinate alternating voltage sources.

32. They system of claim 30, wherein electrical control of said actuators takes place with a primary alternating voltage source and two subordinate alternating voltage sources.

33. The system of claim 31, wherein a supply voltage of said subordinate alternating voltage sources is tapped by said primary alternating voltage source.
